(19) United States
(12) Patent Application Publication
(10) Pub. No.: US 2025/0153370 A1
(43) Pub. Date: May 15, 2025

(54) QUICK CHANGE ACCESSORY FOR MANIPULATING OBJECTS AND RELATED METHODS

(71) Applicant: Capital Recovery Group Technologies, LLC, Louisville, KY (US)

(72) Inventor: Blaze Lysack, Louisville, KY (US)

(21) Appl. No.: 18/943,869

(22) Filed: Nov. 11, 2024

Related U.S. Application Data
(60) Provisional application No. 63/548,013, filed on Nov. 10, 2023.
(60) Provisional application No. 63/711,270, filed on Oct. 24, 2024.

(51) Int. Cl. B25J 15/04; B25J 11/00

(52) U.S. Cl. CPC B25J 15/045; B25J 11/0045

(57) ABSTRACT

A quick change accessory for manipulating an object, such as a food item, is disclosed. The quick change accessory includes a flipper assembly, an accessory for engaging the object, and a mounting block adapted to form a quick change engagement with the accessory. The accessory, which may be a spatula, includes a recess for receiving a locator projection of the mounting block as the accessory is being guided into a receiver of the mounting block. A releasable locking engagement is formed by a fastener associated with the mounting block being urged into a corresponding aperture of the accessory, thus holding the accessory in a fixed position during flipping of the object. The fastener may include a detent associated with a screw body including a spring. In other embodiments, the fastener includes a pin associated with a captured spring.

### CROSS-REFERENCE TO OTHER APPLICATIONS

This application claims the benefit of U.S. Provisional Ser. No. 63/548,013, filed Nov. 10, 2023, and U.S. Provisional Patent Application Ser. No. 63/711,270, filed Oct. 24, 2024, the disclosures of which are incorporated by reference.

### TECHNICAL FIELD

This disclosure relates generally to accessories for manipulating objects and, more particularly, to a quick change accessory for flipping objects, such as food items, during an automated manufacturing process, as well as related methods.

### BACKGROUND

Machines are used for a wide variety of automated manufacturing processes. In some cases, machines include accessories designed to manipulate objects, such as by engaging and moving them. Over time, these accessories may wear out and need replacement or become fouled and need to be cleaned.

Current arrangements often require the use of tools during the changeover process, as well as the need to remove external hardware in order to remove the accessory. As can be appreciated, limiting the amount of time required to remove and replace the accessories is of critical importance, since this procedure takes the machine offline and, as a result, reduces efficiency and increases costs.

Accordingly, a need is identified for a quick change accessory for manipulating objects in the course of an automated manufacturing process involving an associated machine. The accessory would be simple to implement and, particularly, to remove and replace from the associated machine, thus contributing to an overall increase in efficiency in terms of the manufacturing process. Overall, a considerable improvement in the efficiency of the manufacturing operation would be realized, without a concomitant increase in complexity or cost of operation.

### SUMMARY

In one aspect, this disclosure relates to a flipper assembly for flipping pancakes being cooked on a heating element. The flipper assembly includes the accessory for engaging the object, which may comprise a spatula, and a mounting block adapted to form a quick change engagement with the accessory.

The mounting block comprises a receiver for at least partially receiving the accessory and is contoured for fixing a position of the accessory when positioned in the receiver. The mounting block may include at least one tapered face for guiding the accessory into the receiver. As the accessory is guided into the receiver, a recess in the accessory receives a locator projection of the mounting block. To hold the accessory in a fixed position within the receiver, the accessory may include at least one aperture for receiving at least one fastener for connecting with the mounting block.

In some embodiments, the at least one fastener is a threaded or screw body. The screw body includes a hollow bore for receiving a biasing element or spring that urges a detent toward the accessory to engage the at least one aperture of the accessory.

In some embodiments, the at least one fastener is a pin. The pin is associated with a captured spring connected to the mounting block for biasing the pin into engagement with the at least one aperture of the accessory.

A further aspect of the disclosure relates to the machine for manipulating the object, including a support for upholding a plurality of flipper assemblies, according to one or more embodiments shown and described herein. The mounting block is adapted for receiving a connector for connecting to the support. The machine may further include an actuator for advancing, rotating, retracting, or otherwise moving at least one of the plurality of flipper assemblies relative to the support. In some applications, the machine may further include the heating element for heating the object being manipulated.

Yet another aspect of this disclosure is a method for providing the accessory for manipulating the object. The method comprises associating the accessory with the mounting block, lowering and advancing the accessory to engage the object, raising and rotating the accessory to flip the object, and retracting the accessory.

### BRIEF DESCRIPTION OF THE DRAWINGS

While the specification concludes with claims which particularly point out and distinctly claim this technology, it is believed this technology may be better understood from the following description of certain examples taken in conjunction with the accompanying drawings, in which like reference numerals identify the same elements and in which:

FIG. 1 is a perspective view of a machine to which a quick change accessory for manipulating an object may have applicability, according to one or more embodiments shown and described herein;

FIG. 2 is a perspective view of a first embodiment of the quick change accessory, further including a spatula and a mounting block;

FIG. 3 is a cross-sectional view of the spatula, according to one or more embodiments shown and described herein;

FIG. 4 is a rear view of the mounting block of FIG. 2;

FIG. 5 is a perspective view of a lower plate of the mounting block, according to one or more embodiments shown and described herein;

FIG. 6 is a cross-sectional view of a fastener within the mounting block of FIG. 2;

FIG. 7 is an enlarged view of a second embodiment of the quick change accessory, further including the spatula and the mounting block;

FIG. 8 is a perspective view of the quick change accessory of FIG. 7; and

FIG. 9 is a rear view of the quick change accessory of FIG. 7.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

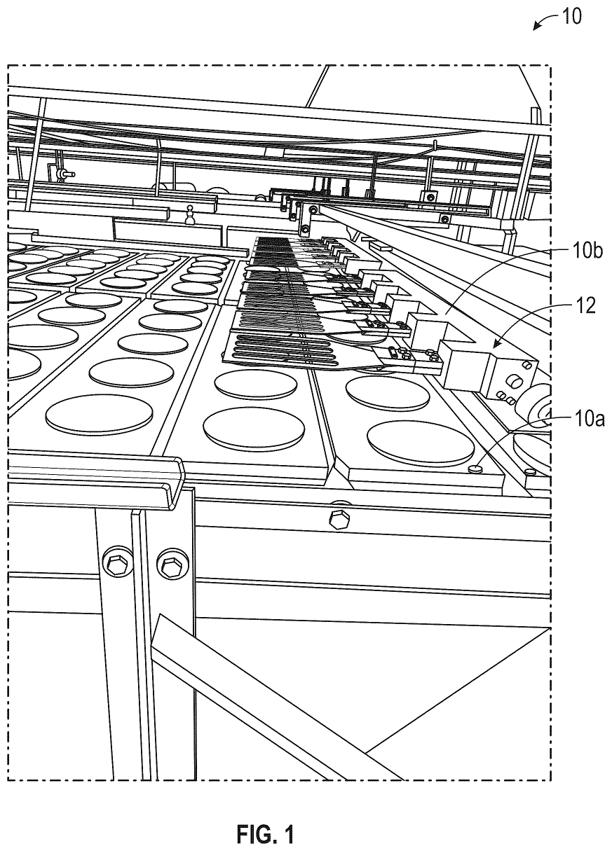

Reference is now made to FIG. 1, which illustrates a machine 10 to which a quick change accessory for manipulating objects according to this disclosure may have applicability. This machine 10 includes a plurality of accessories, which, for purposes of illustration, each takes the form of a flipper assembly 12 for flipping food items during the course of processing, such as pancakes while being cooked on a heating element 10a. A plurality of flipper assemblies 12 may be carried or supported by a common support 10b, which may comprise an elongated bar. The support 10b may be connected to robotic actuators for causing at least one of the plurality of flipper assemblies 12 to advance, retract, lower, raise, flip, or otherwise move in any way necessary to achieve a desired position for object manipulation, such as for successive rows of objects (which may be moving as the result of being associated with a conveyor, in which case the accessories may be stationary relative to the conveying direction, and simply lower, rotate, and raise in order to flip the objects).

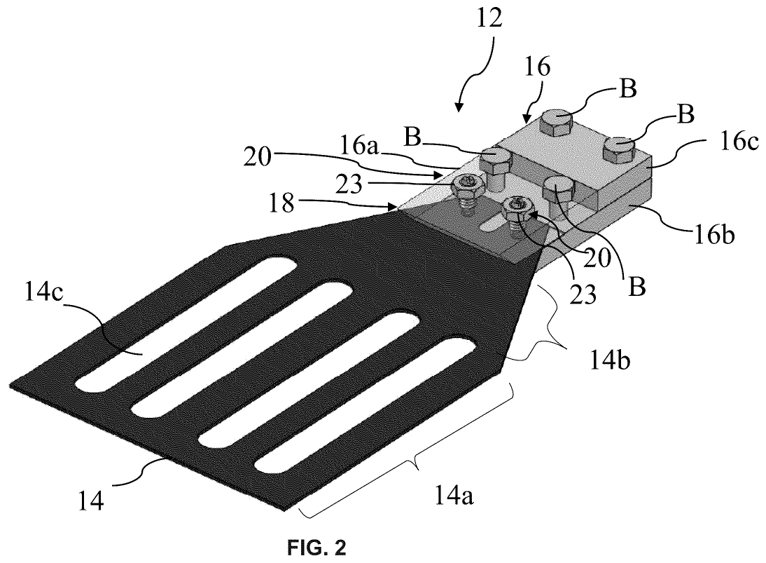

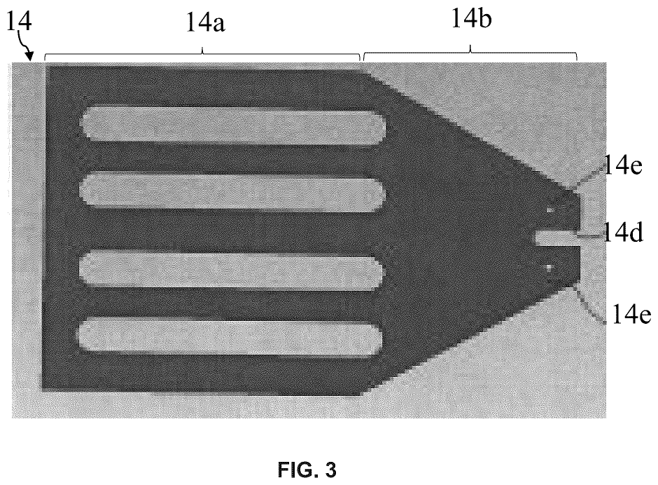

Turning to FIG. 2, a single flipper assembly 12 is shown. The flipper assembly 12 includes a spatula 14 connected to a mounting block 16. The spatula 14 is provided with a generally planar, polygonal body including a forward portion 14a for engaging the object in need of manipulation, and a rearward portion 14b for connecting to the mounting block 16. The forward portion 14a may include one or more openings 14c, which in the case of objects such as food, help to prevent sticking, reduce surface contact, drain excess liquid, and maintain the shape and presentation of the food object. As also shown in the top plan view of the spatula 14 in FIG. 3, the rearward portion 14b, which may be tapered as shown, includes a central slot 14d and adjacent apertures 14e, the functions of which will be better understood upon reviewing the following description.

Turning back to FIG. 2, the mounting block 16 is adapted for partially receiving and gripping the rearward portion 14b of the spatula 14. A forward end of the mounting block 16 includes a forward receiver 18 formed by upper and lower plates 16a, 16b for covering and sandwiching at least part of the rearward portion of the spatula 14. The plates 16a, 16b may be secured together by fasteners 20, such as bolts B, and the upper plate 16a may include openings for receiving one or more of the fasteners 20 for achieving a quick change engagement with the accessory. For purposes of this disclosure, the term “quick change” means capable of being detached quickly and easily and, more specifically, indicates that objects in mechanical engagement (and not necessarily the same two objects) may be detached from each other and reattached without a need for using tools or altering any external hardware to achieve the mechanical engagement.

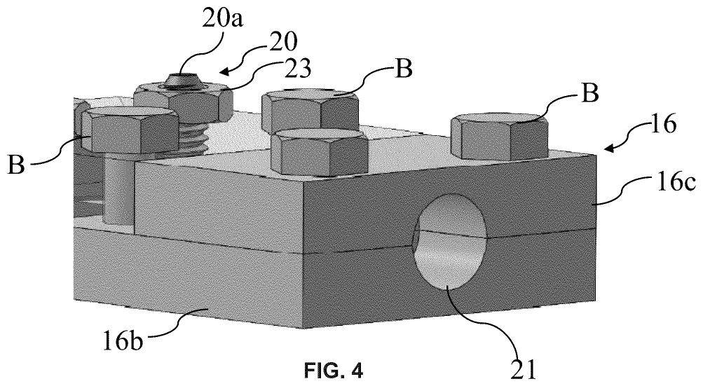

With further reference to FIG. 4, a further plate 16c may be secured to the rearward portion of the lower plate 16b. The securement may also be achieved using fasteners, such as bolts B. Together, these plates 16b, 16c may form a rearward receiver 21 for receiving a connector for connecting to the support 10b.

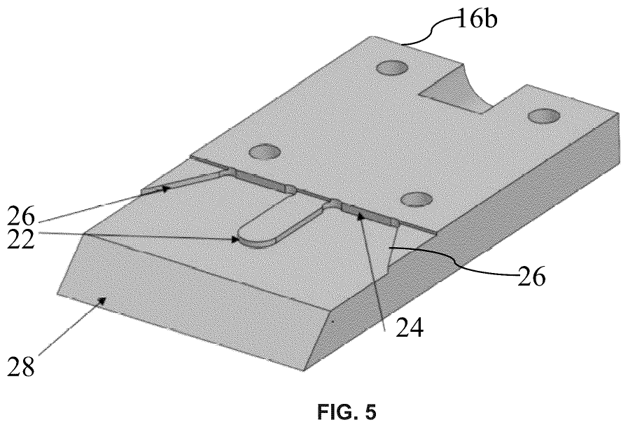

FIG. 5 illustrates in detail the lower plate 16b, which may be adapted for providing a seated engagement for the spatula in order to hold it in a desired (generally planar) position when the mounting block 16 is secured to the support 10b. A forward portion thereof may include a locator projection 22 for engaging the central slot 14d of the spatula 14. A rear ledge 24 may provide a corresponding abutment surface for the rear edge of the spatula 14. Sidewalls 26 may also provide abutment surfaces for corresponding tapered portions along the sides of the rearward portion 14b of the spatula 14. The forward face 28 of the lower plate 16b may also be tapered to assist in guiding the spatula 14 into the receiver 18 during insertion.

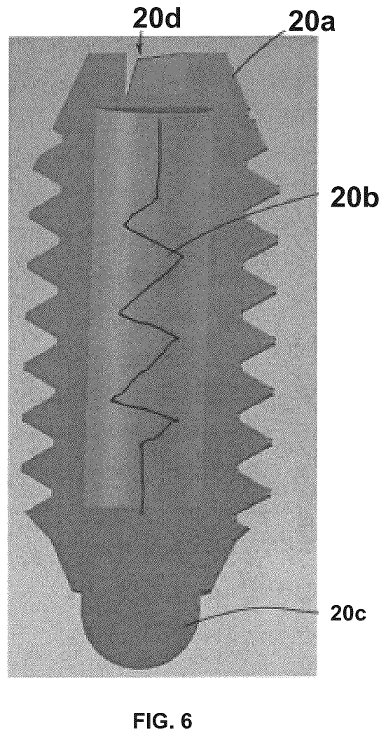

Referring back to FIG. 2 and also referring to FIG. 6, the fasteners 20 used to capture the spatula 14 may each comprise a threaded or screw body 20a. The screw body 20a includes a hollow bore for receiving a biasing element or spring 20b that urges a detent 20c toward the spatula 14 when secured to the mounting block 16. In particular, the distal end of the detent 20c may be rounded for engaging the corresponding aperture 14e in the spatula 14. The degree of engagement may be controlled by raising or lowering the height of the screw body 20a relative to an associated nut 23. This may be facilitated by an upper slot 20d in the screw body 20a designed for receiving a tool, such as the end of a flat head screwdriver. However, as can be appreciated, once the desired degree of holding force is achieved via the height adjustment to capture the spatula 14 within the mounting block 16, the use of a tool is no longer required to remove or reinsert the spatula 14 or other accessory being used therewith.

Thus, in use, the spatula 14 may be inserted in the receiver 18 of the mounting block 16, and the fasteners 20 adjusted to achieve a proper holding force (which may be checked by pulling or tugging on the forward portion 14a of the spatula 14). The flipper assembly 12 may then be used as desired until a need arises for removal of the spatula 14, such as for replacement due to wear or cleaning. To achieve removal, a pulling force may be applied to the forward portion 14a of the spatula 14 sufficient to overcome the spring force on the detents 20c so as to permit withdrawal of the spatula 14 from the mounting block 16. Reinsertion of the cleaned spatula 14 or a replacement may then be achieved by simply pushing the rearward portion 14b into the receiver 18 so that the spring force is overcome and the detents 20c so as to enter the apertures 14e and capture the spatula 14 in position. The use of a tool or the removal of any external hardware may thus be avoided, which reduces complexity and downtime, thereby increasing efficiency, potentially resulting in a considerable cost savings in connection with the manufacturing process.

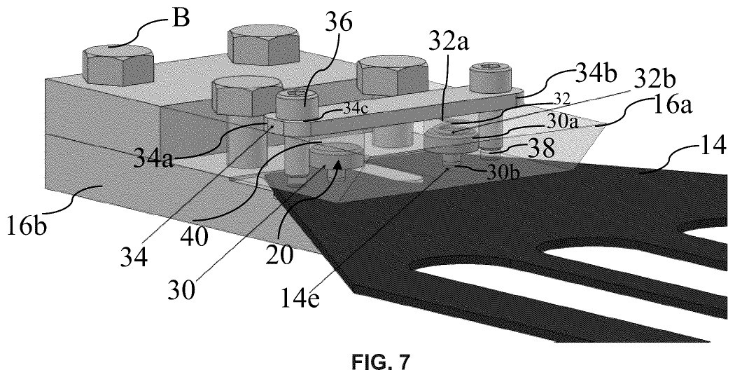

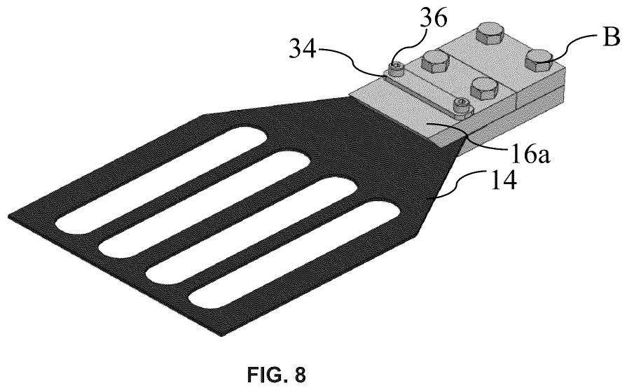

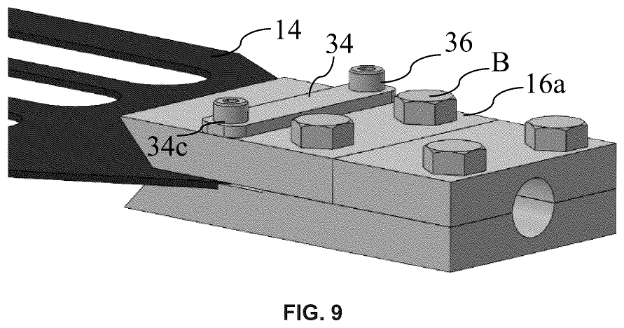

In another embodiment, as shown in FIG. 7, the fasteners 20 used to secure the spatula 14 may each comprise a pin 30. A proximal end of the pin 30a may be connected to a distal end 32b of a captured spring 32. A proximal end 32a of the captured spring 32 may be connected to a plate 34 affixed to the upper plate 16a to hold the captured spring 32 and the pin 30 in place. This plate 34, as further illustrated in FIGS. 8-9, may be secured to the upper plate 16a using plate fasteners 36, such as a first plate fastener 36 at the proximal end 34a and a second plate fastener 36 at the distal end 34b.

Each of the plate fasteners 36 may be mounted in holes 34c in the capture plate 34 and threaded into a corresponding slot 38 in the upper plate 16a of fixed depth. The captured spring 32 and the pin 30 may be housed within a fixed pocket 40 formed in the upper plate 16a, thus ensuring the amount of force of the captured spring 32 and the level of the pin 30 is at a fixed length and force. This configuration may enable the spatula 14 to be held sufficiently during use of the flipper assembly 12 while also maintaining ease of removal during the spatula's 14 insertion/removal process.

In use, the pin 30 is depressed upward into the captured spring 32 during insertion or removal of the spatula 14, eliminating the need for tools. Once the spatula 14 is inserted in the receiver 18 of the mounting block 16, the fasteners 20 are adjusted to achieve a proper holding force, such that the captured spring 32 urges the pin 30 downward into the spatula 14. The pin 30 is spring loaded from the captured spring 32 above to provide enough holding force into the corresponding aperture 14e in the spatula 14. A distal end 30b of the pin 30 may be rounded for engaging the corresponding aperture 14e in the spatula 14.

While the quick change accessory is shown in the form of a spatula or “flipper” for flipping objects, it should be appreciated that aspects of this disclosure may be used in connection with other forms of accessories for manipulating objects in the course of a manufacturing process. For example, the accessory may comprise a cutter, a poker, a prod, a lifter, a turner, a mover, or any other member for manipulating an object, without limitation. Regardless of the particular function performed, the accessory may take any shape or form as needed, provided the desired quick changeability is achieved according to the principles of this disclosure.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of” Each of the phrases “consisting of” and “consists of,” as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic being a system unit system sub-unit device, assembly, sub-assembly, mechanism, structure, component or element or, peripheral equipment utility, accessory, or material, step or procedure, sub-step or sub-procedure), but only if each such additional feature or characteristic does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An apparatus for manipulating an object, comprising:
an accessory for engaging the object; and
a mounting block adapted to form a quick change engagement with the accessory.

2. The apparatus of claim 1, wherein the accessory comprises a spatula.

3. The apparatus of claim 1, wherein the mounting block comprises a receiver for at least partially receiving the accessory.

4. The apparatus of claim 3, wherein the mounting block is contoured for fixing a position of the accessory when positioned in the receiver.

5. The apparatus of claim 4, wherein the accessory includes a recess for receiving a locator projection of the mounting block.

6. The apparatus of claim 1, wherein the mounting block comprises at least one detent for engaging the accessory.

7. The apparatus of claim 6, wherein the at least one detent is associated with a screw body connected to the mounting block, the screw body including a spring for biasing the detent into engagement with the accessory.

8. The apparatus of claim 7, wherein the accessory comprises an aperture for receiving the at least one detent.

9. The apparatus of claim 1, wherein the mounting block comprises at least one pin for engaging the accessory.

10. The apparatus of claim 9, wherein the at least one pin is associated with a captured spring connected to the mounting block for biasing the pin into engagement with the accessory.

11. The apparatus of claim 10, wherein the accessory comprises an aperture for receiving the at least one pin.

12. The apparatus of claim 1, wherein the mounting block includes at least one tapered face for guiding the accessory into the quick change engagement.

13. A machine including a support with a plurality of apparatuses of claim 1.

14. The machine of claim 13, wherein the mounting block is adapted for receiving a connector for connecting to the support.

15. The machine of claim 13, further including an actuator for advancing, rotating, retracting, or otherwise moving at least one of the plurality of apparatuses relative to the support.

16. An apparatus for manipulating an object, comprising:
a spatula for engaging the object;
a mounting block adapted to form a quick change engagement with the spatula; and
at least one fastener for securing the spatula to the mounting block.

17. The apparatus of claim 16, wherein the mounting block comprises a receiver for at least partially receiving the spatula.

18. The apparatus of claim 16, wherein the spatula comprises an aperture for receiving the at least one fastener.

19. A method for mounting an accessory for manipulating an object to a mounting block, comprising:
associating or removing the accessory from mounting block in a quick change manner.

20. The method of claim 19, wherein the accessory comprises a spatula, and the method further comprises fastening the spatula to the mounting block, and removing the spatula from the mounting block, without the use of tools.
